(19) United States
(12) Patent Application Publication
(10) Pub. No.: US 2012/0143409 A1
(43) Pub. Date: Jun. 7, 2012

(54) SHIFT CONTROLLER APPARATUS

(75) Inventors: James Anthony Curtis, Temecula, CA (US); Paul Thomas Geantil, San Diego, CA (US)

(73) Assignee: APTERA MOTORS, INC., Oceanside, CA (US)

(21) Appl. No.: 12/957,771

(22) Filed: Dec. 1, 2010

(51) Int. Cl. B60L 15/20; G05D 1/02; G05G 9/047

(52) U.S. Cl. 701/22; 74/471 XY; 180/65.285; 903/902

(57) ABSTRACT

In accordance with the present invention, a drive mode switch is provided that is configured to move in a rotary motion, a substantially fore-and-aft motion and a substantially cross-vehicle motion. The switch sends a signal that corresponds to each of the motions. A controller is provided that receives the signals from the switch and includes programmed software that correlates the signals to various vehicle motion outputs, such as forward and reverse.

### BACKGROUND & SUMMARY

The present invention generally pertains to automotive vehicles and more particularly to a drive mode switch that communicates with a controller for an electric or hybrid vehicle.

Electric vehicles offer reduced energy consumption as compared to vehicles having internal combustion engines. Electric vehicles still require the ability of an operator to select between various driving modes, such as forward, reverse and park, for example. Some electric vehicles require a dual motion shifting pattern for changing between drive modes. Other electric vehicles require a conventional single linear path of the shifter between park, reverse, neutral and drive. In some examples, it may be awkward and challenging to change between the various driving modes and communicate to a vehicle operator or user the selected drive mode.

In accordance with the present invention, a drive mode switch is provided that is configured to move in a rotary motion, a substantially fore-and-aft motion and a substantially cross-vehicle motion. The switch sends a signal that corresponds to each of the motions. A controller is provided that receives the signals from the switch and includes programmed software that correlates the signals to various vehicle motion outputs, such as forward and reverse. In another aspect, the drive mode switch is a joystick style momentary switch that returns to center. According to other aspects of the present invention, the drive mode switch is configured to switch between different drive modes varying from an economy drive mode, a normal drive mode and a sport (high performance) drive mode. According to still other aspects, the drive mode switch can further include an actuator that mechanically locks the drive mode switch into one position. The actuator can be used to keep the vehicle in park until a brake pedal is pressed. Additional advantages and features of the present invention will be found in the following description and accompanying claims, as well as in the appended drawings.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a perspective view of an automotive vehicle employing a drive mode switch according to the present teachings;

FIG. 2 is a fragmentary perspective view showing an interior of the automotive vehicle employing the drive mode switch;

FIG. 3 is a perspective view of the drive mode switch;

FIG. 4 is a schematic diagram showing different embodiments of the automotive vehicle;

FIG. 5 is a plan view of the drive mode switch of FIG. 3 and illustrating a cylindrical dial moved from a central position (solid line) to a forward position (phantom line) during a drive mode change stroke;

FIG. 6 is a first exemplary logic flow diagram that illustrates the ability of the drive mode switch to communicate with the controller to change the drive modes between neutral, drive, reverse and parking;

FIG. 7 is a second logic flow diagram for software employed in the controller of the present invention;

FIG. 8 is a third logic flow diagram for software employed in the controller of the present invention;

FIG. 9 is a diagram illustrating one exemplary configuration of the drive mode switch;

FIG. 10 is a fourth logic flow diagram for software employed in the controller of the present invention; and

FIG. 11 is a fifth logic flow diagram for software employed in the controller of the present invention.

Corresponding reference numerals indicate corresponding parts throughout the several views of the drawings.

### DETAILED DESCRIPTION

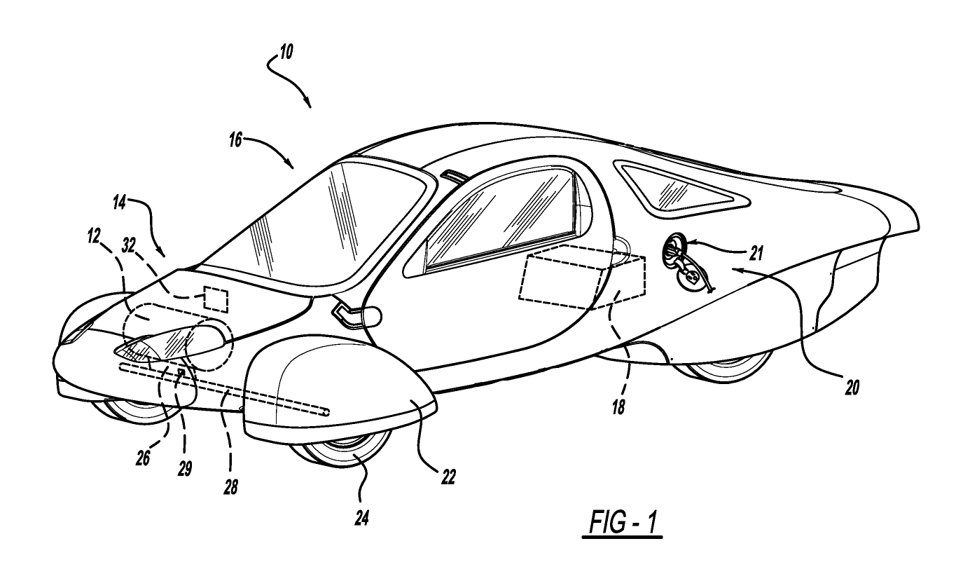

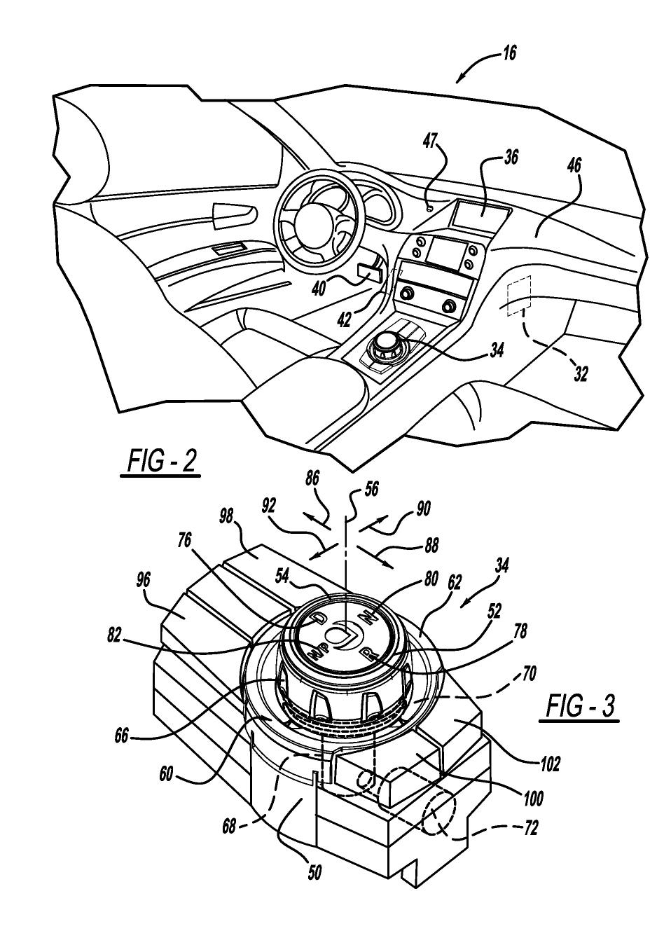

Referring initially to FIGS. 1 and 2, a preferred embodiment of an automotive vehicle 10 has an electric drive traction motor 12 or, alternatively, a hybrid, electric-internal combustion motor assembly, with a front engine compartment 14. A passenger compartment 16 is located rearward of the front engine compartment 14 and contains seats for the vehicle operator. A set of electric batteries 18 are contained within a battery compartment 20 located behind the seats. A plug 21 is provided for connecting to an electric power source for charging the electric batteries 18. The vehicle 10 further includes a pair of fenders 22, which are rotatable with front steering and drive wheels 24 powered by the motor 12. A gear box 26 communicates rotational motion of an output of the motor 12 into rotational motion of an axle 28 connected to the drive wheels 24. A parking pawl 29 is configured on the gear box 26 for selectively inhibiting rotational motion of the gear box 26 when the vehicle 10 is in park.

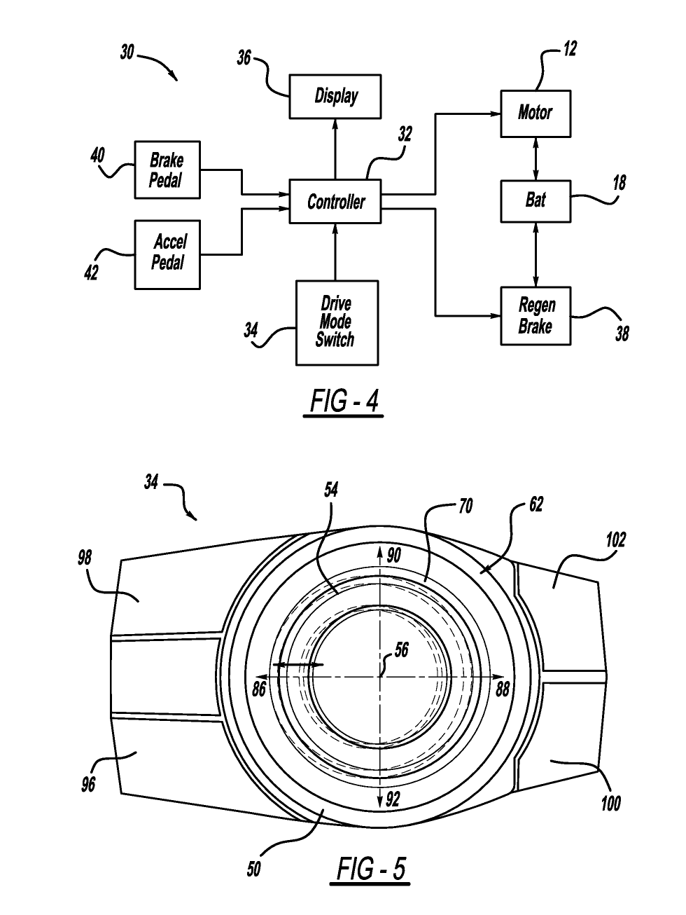

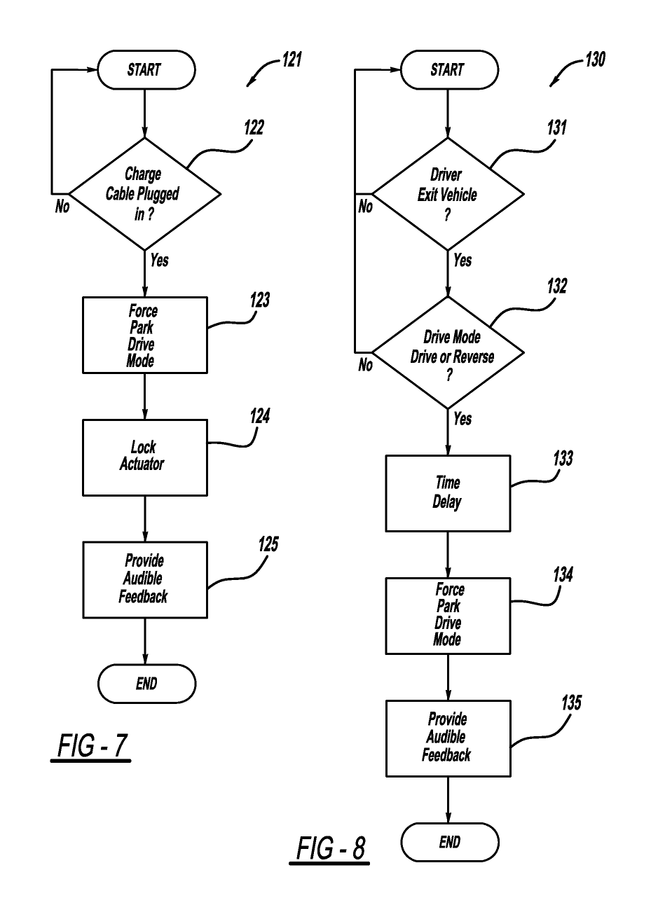

With additional reference now to FIGS. 3 and 4, a drive mode system 30 according to the present invention will be described. The drive mode system 30 includes a microprocessor-based computer controller 32, a drive mode switch 34, a display 36, a regenerative braking system 38 and the motor 12. A brake pedal 40 and accelerator pedal 42 can provide inputs to the controller 32. The controller 32 is located within an instrument panel 46 inside the passenger compartment 16. The controller 32 communicates with a speaker 47 in the instrument panel 46 for providing audible feedback as will be described. Non-transient memory, such as RAM, ROM, or a removable storage device, connected to the controller 32 includes programmed software (such as illustrated in FIGS. 7, 8, 10 and 11) instructions for operating the controller 32. The drive mode system 30 can operate on a controller area network (CAN). As will become appreciated from the following discussion, the drive mode switch 34 is configured to move in multiple directions as well as rotate. Movement of the drive mode switch 34 sends a signal to the controller 32 corresponding to each of the motions. The controller 32 receives the signals from the drive mode switch 34 and the programmed software correlates the signals to various motion outputs, such as forward, rearward, neutral and park.

With reference now to FIGS. 3 and 5, the drive mode switch 34 will be described in greater detail. The drive mode switch 34 generally includes a switch housing 50 and a protruding member 52 extending therefrom. The protruding member 52 is in the form of a cylindrical dial 54. The cylindrical dial 54 extends upright in a static position, such that a longitudinal axis 56 defined through the cylindrical dial 54 is generally perpendicular to a plane 60 defined by a front face 62 of the switch housing 50. More particularly, the longitudinal axis 56 of the cylindrical dial 54 is substantially perpendicular to the plane 60 when the cylindrical dial 54 is in an at rest, first position (as shown in FIG. 3). The cylindrical dial 54 has a plurality of detents 66 arranged around its outer surface to facilitate gripping. A dial boss 68 extends downwardly into the switch housing 50 from the cylindrical dial 54. A spring 70 is arranged between the cylindrical dial 54 and the switch housing 50 to urge the cylindrical dial 54 into the static, first position. An actuator 72 is disposed in the switch housing 50 that mechanically communicates with the dial boss 68 to inhibit movement of the cylindrical dial 54 away from the static first position. The cylindrical dial 54 has first, second, third and fourth indicia 76, 78, 80 and 82, respectively provided thereon. In the exemplary configuration, the first indicia 76 corresponds to a forward drive mode, the second indicia 78 corresponds to a rearward drive mode, the third indicia 80 corresponds to a neutral drive mode and the fourth indicia 82 corresponds to a neutral/park drive mode.

The cylindrical dial 54 is configured to move in a first direction 86 corresponding to the forward drive mode(s), a second direction 88 corresponding to the rearward drive mode, a third direction 90 corresponding to the neutral drive mode and a fourth direction 92 corresponding to the park drive mode. The cylindrical dial 54 is further configured to rotate around the longitudinal axis 56 corresponding to varying degrees of regenerative braking of the regenerative braking system 38. Additional details of the regeneration braking system 38 may be found in commonly owned U.S. patent application Ser. No. ______ (Attorney Docket No. 33321-000007), filed concurrently herewith, which is expressly incorporated herein by reference. In one example, the cylindrical dial 54 can be configured to also be depressed inward or move along the longitudinal axis 56 toward the switch housing 50 to initiate an auxiliary driving mode (such as a parking mode, a valet mode, or other driving modes).

The drive mode switch 34 further includes a first toggle switch 96 and a second toggle switch 98. The first and second toggle switches 96 and 98 can be configured to move the respective left and right windows of the vehicle 10 upward or downward. The drive mode switch 34 also includes a first button 100 and a second button 102. The first and second buttons 100 and 102 can be configured to activate other features of the vehicle 10, such as, but not limited to, a traction control system, a valet mode, a trunk release, a sunroof, a rear window defroster, etc.

As identified above, the cylindrical dial 54 of the drive mode switch 34 is configured to always return to the first or upright position subsequent to moving in any of the directions 86, 88, 90 and 92. In this regard, the cylindrical dial 54 provides a joystick style configuration to a vehicle operator, such that the vehicle operator can quickly and easily toggle between the various drive modes. To further illustrate the momentary feature of the drive mode switch 34, the cylindrical dial 54 is shown translated from the first position (solid line) in the first direction 86 to the second position (phantom line) corresponding to the forward drive mode. The cylindrical dial 54 when released will then, upon urging of the spring 70, return to the upright, static position (solid line). While not specifically identified, those skilled in the art will readily appreciate that the cylindrical dial 54 will return to the central, static position (solid line) subsequent to moving in the other directions 88, 90 or 92. According to the present invention, a signal is sent from the drive mode switch to the controller 32 with each mode change stroke of the cylindrical dial 54. A mode change stroke is defined by movement of the cylindrical dial 54 from the first, static position to any of the forward, rearward, leftward or rightward positions and back to the first position. The controller 32 sends a signal to the display 36 to provide a visual indication to the vehicle operator as to which drive mode has been selected. In other examples, light emitting diodes (LEDs) can be additionally or alternatively provided, such as on the drive mode switch 34 that illuminate according to the selected drive mode. As will become appreciated herein, the drive mode switch 34 and controller 32 are configured to provide multiple forward drive modes. In this regard, a user can sequentially move the cylindrical dial 54 in the first direction 86 and back to the first position to sequence between multiple, distinct, forward driving modes. A user can also sequentially move the cylindrical dial 54 in the fourth direction 92 and back to the first position to initially go to the neutral drive mode and again to go to the park drive mode.

The drive mode switch 34 is configured to communicate corresponding signals to the controller 32 that correspond to a first or normal drive mode, a second or economy drive mode and a third or sport drive mode. In the first drive mode, the vehicle calibrations can be set at nominal values with the preliminary goal of meeting a drive range vehicle target. On exemplary target is a 100 mile minimum drive range. According to one calibration, the appropriate acceleration of the vehicle 10 in the first drive mode can be set to meet a predetermined vehicle level target. One exemplary target is an acceleration from zero to sixty mph in less than ten seconds. The second drive mode is configured to enable the most efficient drive parameters by limiting a maximum torque and speed of the motor 12. In one exemplary calibration, the acceleration of the vehicle 10 can be limited from zero to sixty miles per hour (mph) in less than thirteen seconds. In the third drive mode, the vehicle 10 is configured for higher accelerations and top speed. In one example, the vehicle calibrations in the third drive mode can be set to exceed a target such as to provide acceleration from zero to sixty mph in less than eight seconds. As can be appreciated, the vehicle user will be allowed to specifically tailor their needs according to their particular goals. For example, the second drive mode can be selected when a user desires to achieve the highest range of the vehicle 10. Contrastingly, the third drive mode can be selected when the user wishes to have the highest possible performance while sacrificing vehicle efficiency and range. The drive modes and calibration values listed are merely exemplary. Other and/or additional drive modes may be provided.

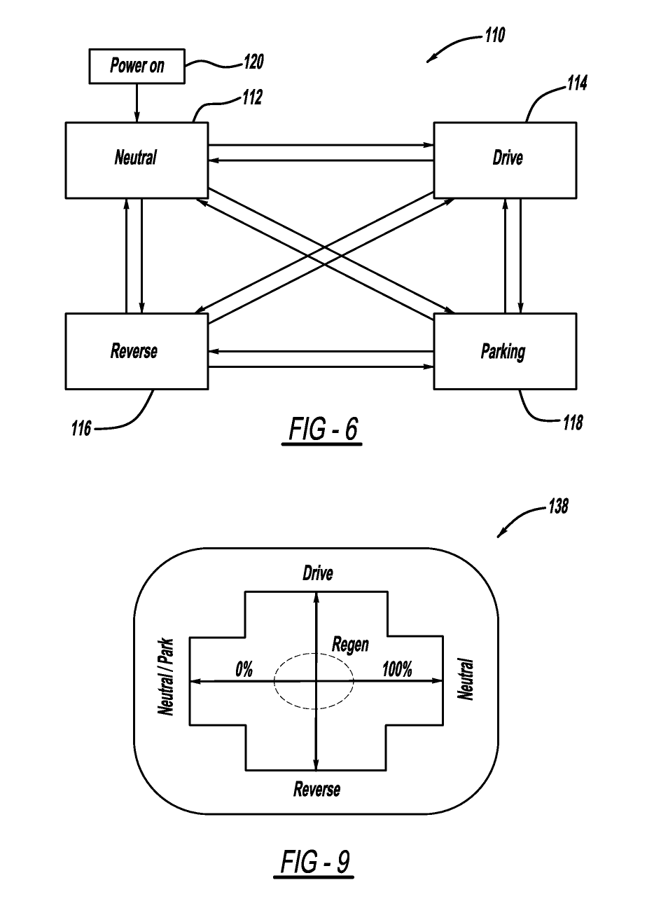

Turning now to FIG. 6, a first logic flow diagram 110 related to the drive mode system 30 is illustrated. The first logic flow diagram 110 generally includes a drive mode status sequence including a neutral drive mode 112, a forward drive mode 114, a reverse drive mode 116 and a parking drive mode 118. In the forward drive mode 118, the electric motor 12 delivers forward motion to the drive wheels 24. In the reverse drive mode 116, the electric motor 12 delivers reverse motion to the drive wheels 24. In the parking drive mode, the drive wheels 24 are precluded from rotating and the parking pawl 29 inhibits rotational motion of the gear box 26. The various drive modes 112-118 can be observed when the power of the vehicle 10 is initiated at block 120. In general, the drive mode switch 34 is configured to permit a user to sequence directly from any of the modes 112, 114, 116 and 118 to another mode 112, 114, 116 and 118 without requiring a user to first enter an intermediate drive mode.

Turning to FIG. 7, a second logic flow diagram 121 is illustrated. The second logic flow diagram 121 illustrates programmed software of the controller 32 during vehicle charging. In step 122, the controller 32 determines if the plug 21 is receiving current during a charge event. If the plug 21 is not receiving current, control loops to step 122. If the plug 21 is receiving current, the controller 32 changes the drive mode to the parking drive mode 118 (FIG. 6) in step 123. The actuator 72 is then engaged to lock the drive mode switch 34 in step 124. The controller 32 then activates the speaker 47 in step 125 to provide an audible feedback than the vehicle 10 is in the parking drive mode 118.

According to one configuration illustrated in the third logic flow diagram 130 of FIG. 8, the drive mode switch 34 is configured to automatically revert back to the parking drive mode 118 if a driver inadvertently leaves the vehicle 10 in either of the forward or reverse drive modes 114, 116. In this regard, the controller 32 determines if the driver has exited vehicle 10 in step 131. In one example, control can determine if the driver has exited by determining if a driver seat is unoccupied (seat sensor) and a driver door is closed (door sensor). In step 132, the controller 32 determines if the current drive mode is either the forward or reverse drive mode 114 or 116. If not, control loops to step 131. If the current drive mode is one of forward or reverse, a time delay is performed in step 133. One exemplary time delay is five minutes. In step 134, the controller 32 forces the drive mode system 30 into the parking drive mode 118. In step 135, the controller 32 then sends a signal to the speaker 47 to provide an audible feedback that the vehicle 10 is in the parking drive mode 118.

Turning now to FIG. 9, an exemplary drive status identifier 138 is illustrated. The drive status identifier 138 generally corresponds to the respective indicia 76, 78, 80 and 82 provided on the cylindrical dial 54 as illustrated in FIG. 3. Other configurations are contemplated.

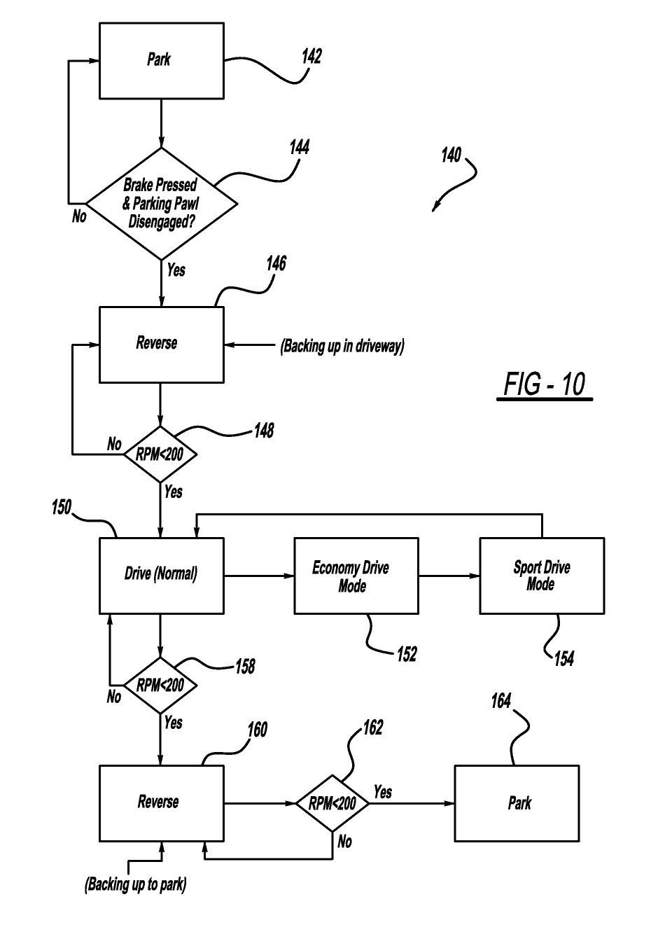

Turning now to FIG. 10, a fourth logic diagram 140 illustrating programmed software of the controller 32 will be described. The fourth logic diagram 140 can represent a daily drive cycle such as commuting to and from work. In step 142, the controller 32 is in park mode. In the park drive mode, the parking pawl 29 locked gear box 26 and therefore inhibits rotation of the drive wheels 24. In step 144, the controller 32 determines if the brake pedal 40 has been depressed and the parking pawl 29 has been disengaged. If the brake pedal 40 and parking pawl 29 have not been disengaged, control loops to step 142. It will be appreciated that depressing the brake pedal 40 causes the actuator 72 to move from an engaged position (inhibiting movement of the cylindrical dial 54) to a disengaged position (allowing movement of the cylindrical dial 54). If the brake pedal 40 has been depressed and the parking pawl 29 has been disengaged, control permits the operator to enter the reverse drive mode 146. In the reverse drive mode, the motor 12 rotates in an opposite direction than the forward drive mode. Again, it will be appreciated that the user can enter the reverse drive mode, such as by translating the cylindrical dial 54 in the second direction 88 as identified in FIG. 3.

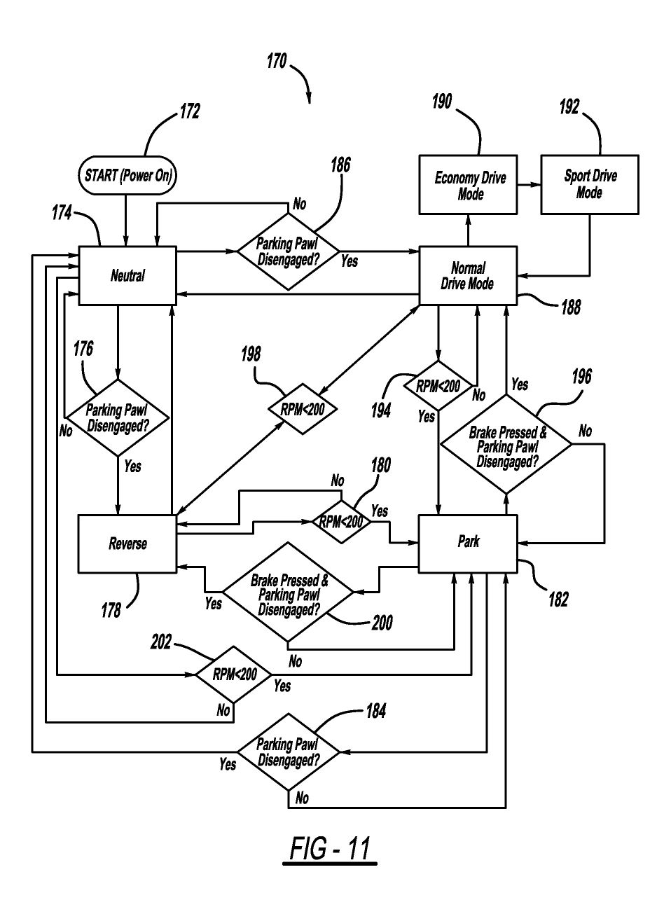

In step 148, the controller 32 determines if the motor 12 has attained a revolutions per minute (RPM) of less than 200. It will be appreciated that the value of 200 used throughout the logic diagrams of FIGS. 10 and 11 herein for the RPM threshold may be changed to other values. If the RPMs are not less than 200, control loops to block 146. If the RPMs are less than 200, control permits entry into the forward drive mode 150. When in the forward drive mode 150, the user is permitted to cycle through sequential drive mode change strokes in the first direction 86 (FIG. 3) to cycle between the forward (normal) drive mode 150, the economy drive mode 152 and the sport mode 154. Again, with each drive mode change, a signal will be communicated to the display 36 to provide a visual indication to the user as to what drive mode the vehicle 10 is in. In decision block 158, the controller 32 determines if the RPMs of the motor 12 are less than 200. If the RPMs of the motor 12 are not less than 200, control loops to block 150. If the RPMs of the motor 12 are less than 200, control permits entry into the reverse drive mode 160. In decision block 162, the controller 32 determines if the RPMs of the motor 12 are less than 200. If the RPMs of the motor 12 are not less than 200, control loops to block 160. If the RPMs of the motor 12 are less than 200, control permits entry into the park mode 164.

Turning now to FIG. 11, a fifth logic diagram 170 illustrating programmed software of the controller 32 will be described. It will be appreciated that the second logic diagram 170 can be carried out alternatively or in addition to the fourth logic diagram 140. In step 172 control verifies that power is on. In step 174, the vehicle 10 is in the neutral drive mode. In the neutral drive mode, the front drive wheels 24 are mechanically free to rotate relative to the drive motor 12. In step 176, control determines if the parking pawl 29 is disengaged. If the parking pawl 29 is not disengaged, control loops to block 174. If the parking pawl 29 is disengaged, control permits entry into the reverse drive mode 178. In step 180, control determines if the RPMs of the motor 12 are less than 200 (or other predetermined value). If the RPMs of the motor 12 are not less than 200, control loops to block 178. If the RPMs of the motor 12 are less than 200, control permits entry into the park drive mode 162. In step 200, control determines if the brake pedal 40 has been depressed and if the parking pawl 29 has been disengaged. If the brake pedal 40 has been depressed and the parking pawl 29 has been disengaged, control permits entry from the park drive mode 182 to the reverse drive mode 178. If at least one of the brake pedal 40 is not pressed or the parking pawl 29 is not disengaged, control loops to block 182. In step 184, control determines if the parking pawl 29 is disengaged. If the parking pawl 29 is disengaged, control permits entry from the park drive mode 182 to the neutral drive mode 174. If the parking pawl 29 is not disengaged, control loops to the park drive mode 182.

In step 186, control determines if the parking pawl 29 is disengaged. If the parking pawl 29 is not disengaged, control loops to the neutral drive mode 174. If the parking pawl 29 is disengaged, control permits entry into the normal drive mode 188. From the normal drive mode 188, a user is permitted to move the cylindrical dial 54 in the first direction 86 (FIG. 3) and back to the upright position (such as by urging of the spring 70) to enter the economy drive mode 190. The user can then move the cylindrical dial 54 in the same manner along the first direction 86 (FIG. 3) and back to the upright position to change into the sport drive mode 192. The user can then move the cylindrical dial 54 again in the first direction 86 and back to the upright position to change the drive mode back to the normal drive mode 188.

In step 194, control determines if the RPMs of the motor 12 are less than 200. If the RPMs of the motor 12 are less than 200, control permits entry from the normal drive mode 188 into the park drive mode 182. If the RPMs of the motor 12 are not less than 200, control loops back to the normal drive mode 188. In step 196, control determines if the brake pedal 40 has been pressed and the parking pawl 29 has been disengaged. If the brake pedal 40 has been pressed and the parking pawl 29 has been disengaged, control permits entry from the park drive mode 182 into the normal drive mode 188. If at least the brake pedal 40 is not pressed or the parking pawl 29 is not disengaged, control loops to the park drive mode 182. In step 198, control determines if the RPMs of the motor 12 are less than 200. If the RPMs of the motor 12 are less than 200, control permits entry from the normal drive mode 188 to the reverse drive mode 178 or alternatively from the reverse drive mode 178 to the normal drive mode 188. In step 202, control determines if the RPMs of the motor 12 are less than 200. If the RPMs of the motor 12 are less than 200, control permits entry into the park drive mode 182 from the neutral drive mode 174. If the RPMs of the motor 12 are not less than 200, control loops back to the neutral drive mode 174.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An automotive vehicle comprising:
a drive motor operable to move the vehicle in a forward direction and a rearward direction, the drive motor being one of: (a) an electric motor, and (b) a hybrid electric/internal combustion motor assembly;
a drive mode switch configured to move in a rotary motion, a substantially fore-and-aft motion and a substantially cross-vehicle motion, the switch sending a signal corresponding to each of the motions; and
a controller receiving the signals from the switch and including programmed software correlating: at least one of the signals to a forward vehicle motion output, at least one of the signals to a rearward vehicle motion output, at least one of the signals to a static vehicle motion output.

2. The automotive vehicle of claim 1 wherein the drive mode switch comprises a protruding member that is operable to deflect from a first position to a second position and automatically return to the first position through the fore-and-aft motion corresponding to the forward vehicle motion output.

3. The automotive vehicle of claim 2 wherein the protruding member is a joy-stick.

4. The automotive vehicle of claim 2 wherein the programmed software of the controller correlates at least one of the signals to a regenerative braking system output.

5. The automotive vehicle of claim 1 wherein the controller is configured to correlate a first fore-and-aft motion to a first forward drive mode, a second sequential fore-and-aft motion to a second forward mode and a third sequential fore-and-aft motion to a third forward drive mode, wherein the first, second and third forward modes each correspond to a distinct drive motor output.

6. An automotive vehicle comprising:
a drive motor operable to move the vehicle in a forward direction and a rearward direction, the drive motor being one of: (a) an electric motor, and (b) a hybrid electric/internal combustion motor assembly;
a drive mode switch comprising a switch housing and a protruding member extending therefrom, the protruding member operable to deflect from a first position to a second position and automatically return to the first position through a forward mode change stroke;
a controller that communicates with the drive mode switch and the drive motor to alter an output of the drive motor based on a selected mode of the drive mode switch; and
wherein the drive mode switch is operable to deflect in successive forward mode change strokes that correspond to at least a first forward drive mode and a second forward drive mode, the second forward drive mode having a distinct drive motor output than the first forward drive mode.

7. The automotive vehicle of claim 6 wherein the first position is an upright position such that a longitudinal axis of the protruding member is substantially transverse to a plane extending through a front face of the switch housing.

8. The automotive vehicle of claim 7 wherein the protruding member comprises a cylindrical dial that is further configured to rotate around the longitudinal axis to alter an operative condition of a regenerative braking system of the vehicle.

9. The automotive vehicle of claim 6 wherein the drive mode switch is operable to deflect from the first position directly to a third position and automatically return to the first position through a reverse mode change stroke that corresponds to the controller altering the output of the drive motor to a reverse direction.

10. The automotive vehicle of claim 9 wherein the forward and reverse mode change strokes are initiated in opposite directions from the first position.

11. The automotive vehicle of claim 8 wherein the first forward drive mode corresponds to a reduced torque and speed output of the drive motor as compared to the second forward drive mode.

12. The automotive vehicle of claim 11 wherein the drive mode switch is further operable to switch to a third forward drive mode that corresponds to an increased torque and speed output of the drive motor as compared to the second forward drive mode.

13. The automotive vehicle of claim 6, further comprising a driver display, wherein the controller communicates with the driver display to provide a visual indication of the selected mode.

14. The automotive vehicle of claim 6, further comprising an actuator disposed on the switch housing that is operable to actuate between locked and unlocked positions wherein the protruding member is fixed in the first position in the locked position, wherein the controller communicates with the actuator to selectively actuate the actuator between the locked and unlocked positions.

15. The automotive vehicle of claim 14 wherein the drive mode switch is operable to deflect from the first position directly to a third position and automatically return to the first position through a parking mode change stroke.

16. The automotive vehicle of claim 6 wherein the switch housing further comprise first and second toggle switches that communicate with the controller to move a first and second window, respectively, of the vehicle.

17. A method of changing a drive mode in an automotive vehicle, the method comprising:
providing a drive motor operable to move the vehicle in a forward direction and a rearward direction, the drive motor being one of: (a) an electric motor, and (b) a hybrid electric/internal combustion motor assembly;
providing a drive mode switch that is configured to move in a substantially fore-and-aft motion and a substantially cross-vehicle motion, the switch sending a signal corresponding to each of the motions;
determining if the drive mode switch has been actuated through a first forward drive mode change stroke;
determining if the drive mode switch has been actuated through a second forward drive mode change stroke, the second forward drive mode change stroke being equivalent in movement and subsequent in occurrence to the first forward drive mode change stroke; and
altering an output of the drive motor based on the determination wherein the drive motor output is distinct for the first and second forward drive mode change strokes.

18. The method of claim 17, further comprising:
determining if the drive mode switch has been actuated through a rearward drive mode change stroke, the rearward drive mode change stroke initiating in an opposite direction than the first forward drive mode change stroke; and
altering a rotational direction of the output of the drive motor based on the determination.

19. The method of claim 18, further comprising:
determining if the drive mode switch has been actuated through a park drive mode change stroke, the park drive mode change stroke initiating in a transverse direction relative to the first forward drive mode change stroke; and
terminating power to the drive motor; and
moving an actuator on the drive mode switch to an engaged position based on the determination, the actuator inhibiting movement of the drive mode switch.

20. The method of claim 19, further comprising:
determining if a brake pedal of the vehicle has been depressed; and
moving the actuator to a disengaged position with the drive mode switch based on the determination.

21. A method of changing a drive mode in an automotive vehicle, the method comprising:
providing a drive motor operable to move the vehicle in a forward direction and a rearward direction, the drive motor being one of: (a) an electric motor, and (b) a hybrid electric/internal combustion motor assembly;
providing a drive mode switch that is configured to move in a substantially fore-and-aft motion and a substantially cross-vehicle motion, the switch sending a signal corresponding to each of the motions, wherein at least one of the motions corresponds to a forward drive mode and another of the motions corresponds to a reverse drive mode;
determining in a first criteria if a current drive mode is one of forward and reverse;
determining in a second criteria if a vehicle operator is away from the vehicle; and
changing the current drive mode to a park drive mode if the first and second criteria are satisfied.

22. The method of claim 21 wherein determining if the vehicle operator is away from the vehicle comprises determining if a driver's seat of the vehicle is unoccupied.

23. The method of claim 21, further comprising determining in a third criteria if a predetermined time frame has lapsed and changing the current drive mode if the first, second and third criteria are satisfied.

24. The method of claim 23, further comprising determining in a fourth criteria if a door of the vehicle is closed and changing the current drive mode if the first, second, third and fourth criteria are satisfied.

25. A method of changing a drive mode in an automotive vehicle, the method comprising:
providing a drive motor operable to move the vehicle in a forward direction and a rearward direction, the drive motor being one of: (a) an electric motor, and (b) a hybrid electric/internal combustion motor assembly;
providing a drive mode switch that is configured to move in a substantially fore-and-aft motion and a substantially cross-vehicle motion, the switch sending a signal corresponding to each of the motions, wherein at least one of the motions corresponds to a forward drive mode and another of the motions corresponds to a reverse drive mode;
determining in a first criteria if the vehicle is charging; and
changing the current drive mode to a park drive mode based on the determination.

26. The method of claim 25, further comprising locking the drive mode switch from moving based on the determination.
